(19) United States
(12) Patent Application Publication
(10) Pub. No.: US 2019/0256742 A1
(43) Pub. Date: Aug. 22, 2019

(54) POLISHING COMPOSITION, METHOD FOR PRODUCING POLISHING COMPOSITION, AND POLISHING METHOD

(71) Applicant: FUJIMI INCORPORATED, Kiyosu-shi, Aichi (JP)

(72) Inventors: Shota SUZUKI, Kiyosu-shi (JP); Yoshihiro IZAWA, Kiyosu-shi (JP); Naoyuki ISHIHARA, Kiyosu-shi (JP)

(73) Assignee: Fujimi Incorporated, Kiyosu-shi, Aichi (JP)

(21) Appl. No.: 16/317,383

(22) PCT Filed: Jun. 12, 2017
(86) PCT No.: PCT/JP2017/021692

§ 371 Date: Jan. 11, 2019

(30) Foreign Application Priority Data
Jul. 15, 2016 (JP) 2016-140613
Nov. 18, 2016 (JP) 2016-224956

(51) Int. Cl. C09G 1/02; B24B 37/04; C09K 3/14

(52) U.S. Cl. CPC C09G 1/02; C09K 3/1463; B24B 37/044

(57) ABSTRACT

The present invention provides a polishing composition that can polish an object to be polished at a high polishing speed with fewer scratches (defects). The present invention relates to a polishing composition including silica and a dispersing medium, the polishing composition having, when analyzed by pulse NMR spectroscopy, a specific relaxation rate (R₂ₛₚ) of from 1.60 to 4.20 as determined by the following Formula (1):

R₂ₛₚ=(R_{(silica)})/(R_{(medium)})−1 Formula (1):

wherein R(_{silica)} represents the reciprocal of the relaxation time of silica (unit:/millisecond), and R(_{medium)} represents the reciprocal of the relaxation time of the dispersing medium (unit:/millisecond).

### TECHNICAL FIELD

The present invention relates to a polishing composition, a method for producing a polishing composition, and a polishing method.

### BACKGROUND ART

In recent years, along with multilayer wiring on the surface of semiconductor substrates, a so-called chemical mechanical polishing (CMP) technique for polishing and flattening a semiconductor substrate is utilized at the time of device production. CMP is a method of flattening the surface of an object to be polished (object of polishing), such as a semiconductor substrate, using a polishing composition (slurry) including abrasive grains of silica, alumina, ceria, or the like, an anti-corrosion agent, a surfactant, and the like. Examples of the object to be polished (object of polishing) include wirings and plugs formed from silicon, polysilicon, a silicon oxide film (silicon oxide), silicon nitride, a metal, or the like.

For example, as a CMP slurry for polishing a substrate containing oxygen atoms and silicon atoms, such as silicon oxide, JP 2001-507739 W (corresponding to the specification of U.S. Pat. No. 5,759,917 B) discloses an aqueous chemical mechanical polishing composition including a salt, soluble cerium, a carboxylic acid, and silica (particularly, fumed silica). Furthermore, JP 2015-063687 A (corresponding to the specification of U.S. Pat. No. 9,012,327 B discloses a chemical mechanical polishing composition including water, 0.1 wt % to 40 wt % of colloidal silica particles, and 0.001 wt % to 5 wt % of an additive (pyridine derivative).

### SUMMARY OF INVENTION

However, when the aqueous chemical mechanical polishing composition described in JP 2001-507739 A (corresponding to the specification of U.S. Pat. No. 5,759,917 B) is used, the speed of polishing a substrate is increased; however, there is a problem that large quantities of scratches are produced on the substrate surface.

Furthermore, when the chemical mechanical polishing composition described in JP 2015-063687 A (corresponding to the specification of U.S. Pat. No. 9,012,327 B) is used, scratches on the substrate surface are suppressed; however, there is a problem that the polishing speed is not sufficient.

As such, for the polishing of an object to be polished containing oxygen atoms and silicon atoms, there has been a demand for a polishing composition that can increase the polishing speed and can reduce scratches (defects), in other words, a polishing composition that can solve contrary problems.

Thus, the present invention was achieved in view of such circumstances, and it is an object of the invention to provide a polishing composition that can polishing an object to be polished (particularly, an object to be polished containing oxygen atoms and silicon atoms) at a high polishing speed and can reduce scratches (defects) on the surface of the object to be polished.

The inventors of the present invention conducted a thorough investigation in order to solve the above-described problems. As a result, the inventors found that the problems described above can be solved by appropriately controlling the specific relaxation rate of the polishing composition. Thus, the inventors finally completed the present invention based on the findings.

That is, the above object is achieved by a polishing composition containing silica and a dispersing medium,

the polishing composition having, when analyzed by pulse NMR spectroscopy, a specific relaxation rate (R₂ₛₚ) of from 1.60 to 4.20 as determined by the following Formula (1):

[Expression 1]

R₂ₛₚ=(R_{(silica)})/(R_{(medium)})−1 Formula (1):

wherein R_{(silica)} represents a reciprocal of a relaxation time of silica (unit:/millisecond), and R_{(medium)} represents a reciprocal of a relaxation time of a dispersing medium (unit:/millisecond).

### BRIEF DESCRIPTION OF DRAWINGS

FIG. 1 is a schematic diagram for describing the action of abrasive grains on an object to be polished.

### DESCRIPTION OF EMBODIMENTS

An aspect of the present invention relates to a polishing composition containing silica and a dispersing medium, the polishing composition having, when analyzed by pulse NMR spectroscopy, a specific relaxation rate (R₂ₛₚ) of from 1.60 to 4.20 as determined by the following Formula (1):

[Expression 2]

R₂ₛₚ=(R_{(silica)})/(R_{(medium)})−1 Formula (1):

Here, R_{(silica)} represents the reciprocal of the relaxation time of silica (unit:/millisecond), and R_{(medium)} represents the reciprocal of the relaxation time of the dispersing medium (unit:/millisecond). A polishing composition having such a configuration can polish an object to be polished (particularly, an object to be polished containing oxygen atoms and silicon atoms) at a high polishing speed and can reduce scratches (defects) on the surface of the object to be polished.

According to the present specification, the specific relaxation rate (R₂ₛₚ) that is determined by the above-described Formula (1) when analyzed by pulse NMR spectroscopy, may also be simply referred to as “specific relaxation rate (R₂ₛₚ)”, “specific relaxation rate”, or “R₂ₛₚ”.

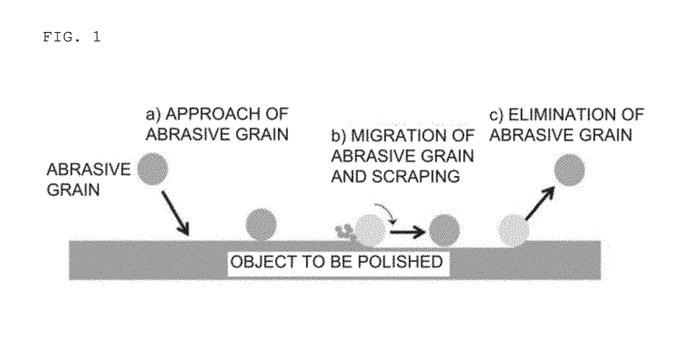

Conventionally, with regard to semiconductor devices for which multi-layering is underway, there is a demand to develop a technology for polishing an interlayer insulating film (for example, a SiO₂ film) at a higher polishing speed. Generally, the mechanical action by which abrasive grains polish an object to be polished is based on the following mechanism. That is, as illustrated in FIG. 1, abrasive grains approach an object to be polished ((a) in FIG. 1). Next, as the abrasive grains migrate on the object to be polished, the substrate surface is scraped (polished) ((b) in FIG. 1), and the abrasive grains are finally eliminated from the object to be polished ((c) in FIG. 1). In the above-described action, in order to achieve a high polishing speed, attention has been paid to a process in which the abrasive grains approach the object to be polished ((a) in FIG. 1), and attempts have been made to enhance polishing brought by the action of abrasive grains by increasing the frequency of approach and/or contact of the abrasive grains to or with the object to be polished. Regarding the method of increasing the frequency of approach and/or contact of abrasive grains to or with an object to be polished, example, there have been suggested a method of increasing the number of abrasive grains; a method of enlarging the size of the abrasive grains; a method of using irregular-shaped abrasive grains; a method of using abrasive grains having a zeta potential with an opposite sign to that of the object to be polished; a method of adding a salt and thereby making the absolute values of the zeta potentials of the abrasive grains and the object to be polished small; and the like. However, in order to sufficiently satisfy the demand for a higher polishing speed and the demand for reduction of scratches (defects) of recent years, it is not likely to be able to fulfill the demands only by simply combining those existing technologies described above.

In order to solve the problems described above, the inventors of the present invention conducted a thorough investigation. As a result, the inventors paid attention to the finding that the binding amount of the dispersing medium to the surface of silica (abrasive grains) is effective for increase in the polishing speed and reduction of defects. In regard to this attention, the inventors further conducted a thorough investigation, and as a result, the inventors found that when a polishing composition that has a specific relaxation rate (R₂ₛₚ), which serves as an index for the amount of layer on the surface of abrasive grains, in a particular range of from 1.60 to 4.20 is used, both a high polishing speed and reduction of scratches (defects) can be achieved. Meanwhile, as will be described below, the specific relaxation rate (R₂ₛₚ) is an index for the binding amount of the dispersing medium to the surface of the abrasive grains (therefore, the amount of free dispersing medium that is not bound to the surface of the abrasive grains), and a higher specific relaxation rate (R₂ₛₚ) means a larger binding amount of the dispersing medium to the surface of abrasive grains (that is, the amount of the layer or the thickness of the layer on the surface of abrasive grains).

The detailed mechanism that provides the above-described effect is still not clearly understood; however, the mechanism may be considered as follows. That is, in a polishing composition including silica (abrasive grains) and a dispersing medium (solvent), the dispersing medium binds to the silica surface, and thereby, the silica is coated with the dispersing medium. For example, in a polishing composition including silica and water, silanol groups existing at the surface of silica particles form hydrogen bonding with water molecules, and a layer of water molecules is formed on the surface of the abrasive grains. As this layer of water molecules is thinner (the amount of bound water is smaller, and therefore, the specific relaxation rate (R₂ₛₚ) is smaller), the distance between the silica and the object to be polished is shorter. Therefore, silica can easily approach and adhere to the object to be polished at a high frequency. Accordingly, even with a smaller amount (lower concentration) of silica, silica approaches and adheres to the object to be polished efficiently (at a high frequency) and efficiently scrapes (polishes) the surface of the object to be polished. Furthermore, in a case where the layer of water molecules is thin (the amount of bound water is small, and therefore, the specific relaxation rate (R₂ₛₚ) is small), the distance between the silica particles and the surface of the object to be polished is short. Therefore, silanol groups at the silica surface and the dispersing medium on the surface of the object to be polished can bind to each other more easily. For example, in a polishing composition including silica and water, silanol groups at the surface of silica particles form hydrogen bonding with a water layer on the surface of the object to be polished. Therefore, the silica particles are retained on the surface of the object to be polished, and the time taken by the silica particles to migrate on the surface of the object to be polished is increased. Thus, since the time required for the silica particles to be eliminated from the object to be polished is long, the silica particles scrape (polish) the substrate surface for a longer time (more efficiently) . Therefore, when the layer of water molecules is thin (the amount of bound water is small), the polishing speed can be increased. Furthermore, as described above, since the migration length of the silica particles on the surface of the object to be polished is long, the silica particles happen to scrape out (remove) scratches that exist on the surface of the object to be polished during the migration. Therefore, by having a lower specific relaxation rate (R₂ₛₚ), the polishing speed can be increased, and scratches (defects) can be reduced. On the other hand, since the layer of water on the surface of the silica particles suppresses and prevents aggregation of silica particles, the size of scratches (defects) generated when the silica particles approach and adhere to the surface of the object to be polished can be reduced. Therefore, it is preferable that a layer of water molecules having a thickness of the extent that aggregation of silica particles can be prevented exists on the surface of the silica particles. Therefore, from the viewpoint of reducing scratches (defects), it is preferable that the layer of water molecules has a certain thickness, that is, the specific relaxation rate (amount of bound water) is controlled to a certain range. The inventors conducted a thorough investigation on the balance between contrary effects, namely, increase in the polishing speed and reduction of scratches (defect). As a result, when the specific relaxation rate (R₂ₛₚ) is from 1.60 to 4.20, both the increase in the polishing speed and the reduction of scratches (defects) can be achieved in a well-balanced manner.

Therefore, when the polishing composition according to an embodiment of the present invention is used, an object to be polished can be polished at a high polishing speed while generating fewer scratches (defects). Furthermore, as described above, when the polishing composition of the present invention is used, silica (abrasive grains) easily approaches and adheres to the object to be polished at a high frequency, and silica stays on the surface of the object to be polished for a long time. Therefore, when the polishing composition according to an embodiment of the present invention is used, even if silica is included at a lower concentration, the object to be polished can be polished at a high polishing speed while generating fewer scratches (defects), and therefore, it is preferable also from the viewpoint of cost.

Hereinafter, the present invention will be described in detail. Unless particularly stated otherwise, operations and measurement of physical properties and the like are carried out under the conditions of room temperature (20° C. to 25° C.)/relative humidity of 40% RH to 50% RH.

### Object to be Polished

The object to be polished according to an embodiment of the present invention is not particularly limited, and examples include an object to be polished having a metal, oxygen atoms, and silicon atoms; an object to be polished having a silicon-silicon bond; and an object to be polished having nitrogen atoms and silicon atoms.

Examples of the metal include copper, aluminum, hafnium, cobalt, nickel, titanium, tungsten, and the like.

Examples of the object to be polished having oxygen atoms and silicon atoms include silicon oxide (SiO₂) tetraethyl orthosilicate (TEOS), and the like.

Examples of the object to be polished having a silicon-silicon bond include polysilicon, amorphous silicon, single crystal silicon, n-type doped single crystal silicon, p-type doped single crystal silicon, Si-based alloys such as SiGe, and the like.

Examples of the object to be polished having nitrogen atoms and silicon atoms include a silicon nitride film, and an object to be polished having a silicon-nitrogen bond, such as SiCN (silicon carbonitride).

These materials may be used singly, or two or more kinds thereof may be used in combination.

Among these, in a case where an object to be polished containing oxygen atoms and silicon atoms is used, the effects provided by the present invention can be exhibited more effectively. In a case where an object to be polished including a silicon oxide film formed from tetraethyl orthosilicate (TEOS) as a raw material is used, the effects provided by the present invention can be exhibited more effectively. That is, according to a preferred embodiment of the present invention, the polishing composition related to an embodiment of the present invention is used for polishing an object to be polished containing oxygen atoms and silicon atoms. According to a particularly preferred embodiment of the present invention, the object to be polished is a substrate including a silicon oxide film formed from tetraethyl orthosilicate as a raw material.

Therefore, another aspect of the present invention is to provide a polishing method, the method including polishing an object to be polished containing oxygen atoms and silicon atoms using the polishing composition according to an embodiment of the present invention. Furthermore, according to a preferred embodiment of the present invention, a polishing method including polishing an object to be polished containing a silicon oxide film formed from tetraethyl orthosilicate (TEOS) as a raw material using the polishing composition according to an embodiment of the present invention, is provided. Then, still another aspect of the present invention is to provide a method for producing a polished object to be polished, the method including polishing an object to be polished using the polishing method according to an embodiment of the present invention.

The object to be polished according to an embodiment of the present invention is preferably a material containing oxygen atoms and silicon atoms; however, even in this case, the object to be polished may further include another material in addition to the above-described material. Examples of the other material include silicon nitride (SiN), silicon carbide (SiC), sapphire (Al₂O₃), silicon-germanium (SiGe), and the like.

These objects of polishing are not particularly limited as long as they can be polished with the polishing composition according to an embodiment of the present invention; however, the object to be polished is preferably a substrate, and more preferably a semiconductor substrate.

### Polishing Composition

The polishing composition according to an embodiment of the present invention includes silica and a dispersing medium and has a specific relaxation rate (R₂ₛₚ) of from 1.60 to 4.20. Here, the specific relaxation rate (R₂ₛₚ) as measured by pulse NMR spectroscopy is determined by the following Formula (1):

[Expression 3]

R₂ₛₚ=(R_{(silica)})/(R_{(medium)})−1 Formula (1):

Here, in Formula (1), R_{(silica} represents the reciprocal of the relaxation time (unit:/millisecond) of silica, and R_{(medium)} represents the reciprocal of the relaxation time (unit:/millisecond) of the dispersing medium.

Here, when the specific relaxation rate (R₂ₛₚ) is less than 1.60, the amount of the dispersing medium binding to silica is so small (the layer of water molecules on the surface of the silica particles is so thin) that the silica particles aggregate with one another, and consequently, scratches (defects) on the surface of the object to be polished that has been polished cannot be reduced (see Comparative Example 1 described below). Furthermore, since the actual number of particles is also reduced as the result of aggregation of silica, the polishing speed is also low. On the other hand, when the specific relaxation rate (R₂ₛₚ) is more than 4.20, the amount of the dispersing medium binding to silica is so large (the layer of water molecules on the surface of the silica particles is so thick) that the distance between the silica particles and the surface of the object to be polished becomes too large, and the silica cannot sufficiently approach and adhere to the surface of the object to be polished. Accordingly, the silica particles cannot exist on the surface of the object to be polished for a sufficient time, and the polishing efficiency (polishing speed) is lowered (see Comparative Examples 2 to 4 described below). Furthermore, as the large amount of the dispersing medium bound to silica actively form hydrogen bonding or the like with polishing waste and the like and forms aggregates, scratches on the polished surface of the object to be polished cannot be reduced. From the viewpoint of achieving both the increase in the polishing speed and the reduction of scratches (defects) in a more well-balanced manner, the lower limit of the specific relaxation rate (R₂ₛₚ) is preferably 2.00 or more, more preferably 2.50 or more, even more preferably 3.00 or more, and still more preferably 3.50 or more. Furthermore, from the viewpoint of achieving both the increase in the polishing speed and the reduction of scratches (defects) in a more well-balanced manner, the upper limit of the specific relaxation rate (R₂ₛₚ) is preferably 4.15 or less, more preferably less than 4.15, even more preferably 4.10 or less, still more preferably 4.00 or less, particularly preferably 3.90 or less, and most preferably 3.80 or less. That is, the specific relaxation rate (R₂ₛₚ) is preferably 1.60 or more and 4.15 or less, more preferably 2.00 or more and less than 4.15, even more preferably 3.00 or more and 4.10 or less, still more preferably 3.00 or more and 4.00 or less, particularly preferably 3.50 or more and 3.90 or less, and most preferably 3.50 or more and 3.80 or less. When the specific relaxation rate is in such a range, both the increase in the polishing speed and the reduction of scratches (defects) can be achieved in a more well-balanced manner. Particularly, when the specific relaxation rate is in the above-described range, the polishing speed can be increased more effectively.

In regard to the polishing composition according to an embodiment of the present invention, the relaxation time of silica as measured by pulse NMR spectroscopy (therefore, the reciprocal of the relaxation time of silica) or the relaxation time of water as measured by pulse NMR spectroscopy (therefore, the reciprocal of the relaxation time of water) is not particularly limited as long as the specific relaxation rate (R₂ₛₚ) is from 1.60 to 4.20. From the viewpoint of achieving the increase in the polishing speed and the reduction of scratches (defects) in a more well-balanced manner, the lower limit of the relaxation time of silica as measured by pulse NMR spectroscopy is preferably 460 milliseconds or longer, more preferably 470 milliseconds or longer, even more preferably 475 milliseconds or longer, still more preferably 480 milliseconds or longer, particularly preferably 490 milliseconds or longer, and most preferably 500 milliseconds or longer. Furthermore, from the viewpoint of achieving both the increase in the polishing speed and the reduction of scratches (defects) in a more well-balanced manner, the upper limit of the relaxation time of silica as measured by pulse NMR spectroscopy is preferably 900 milliseconds or shorter, more preferably 800 milliseconds or shorter, even more preferably 600 milliseconds or shorter, and particularly preferably 525 milliseconds or shorter. That is, the relaxation time of silica as measured by pulse NMR spectroscopy is preferably from 460 milliseconds to 900 milliseconds, more preferably from 470 milliseconds to 800 milliseconds, even more preferably from 475 milliseconds to 600 milliseconds, still more preferably from 480 milliseconds to 600 milliseconds, particularly preferably from 490 milliseconds to 600 milliseconds, and most preferably from 500 milliseconds to 525 milliseconds. That is, according to a preferred embodiment of the present invention, the relaxation time of silica as measured by pulse NMR spectroscopy is from 460 milliseconds to 900 milliseconds. According to a more preferred embodiment of the present invention, the relaxation time of silica as measured by pulse NMR spectroscopy is from 470 milliseconds to 800 milliseconds. According to an even more preferred embodiment of the present invention, the relaxation time of silica as measured by pulse NMR spectroscopy is from 475 milliseconds to 600 milliseconds. According to a still more preferred embodiment of the present invention, the relaxation time of silica as measured by pulse NMR spectroscopy is from 480 milliseconds to 600 milliseconds. According to a particularly preferred embodiment of the present invention, the relaxation time of silica as measured by pulse NMR spectroscopy is from 490 milliseconds to 600 milliseconds. According to the most preferred embodiment of the present invention, the relaxation time of silica as measured by pulse NMR spectroscopy is from 500 milliseconds to 525 milliseconds. When the relaxation time of silica is in such a range, both the increase in the polishing speed and the reduction of scratches (defects) can be achieved in a more well-balanced manner. Particularly, when the relaxation time of silica is in the above-described range, the polishing speed can be increased more effectively.

Here, the specific relaxation rate (R₂ₛₚ) is an index for the amount of the dispersing medium binding to the surface of silica particles (silanol groups) (binding amount of the dispersing medium). Generally, as will be described below, when electromagnetic waves are applied to a sample, the nuclear spin of protons in the sample enters an excited state with aligned directions. The process in which this excited state returns to the original basal state where the directions are random is referred to as “relaxation”, and the time taken for this process is referred to as “relaxation time”. Regarding pulse NMR spectroscopy, since the solvent (dispersing medium) molecules that are in contact with or have adsorbed to the particle surface, and the solvent molecules that are not immobilized on the silica surface (solvent molecules in a free state, which are not in contact with the particle surface) have different responses to changes in the magnetic field, pulse NMR spectroscopy is an analysis method of utilizing the fact that those solvent molecule have different relaxation times. The movement of liquid molecules adsorbing to the particle surface (solvent molecules that are in contact with or have adsorbed to the particle surface) is restrained; however, the solvent molecules that are not immobilized on the silica surface (solvent molecules in a free state, which are not adsorbed to the particle surface) can move freely. Therefore, the relaxation time of liquid molecules adsorbed to the particle surface becomes shorter than the relaxation time of the solvent molecules that are not immobilized on the silica surface.

Therefore, in the present invention, the amount of water molecules bound to silanol groups at the surface of silica particles (amount of bound water at the surface of abrasive grains) is evaluated according to the difference in the relaxation time (that is, specific relaxation rate).

In the present specification, Tor the specific relaxation rate (R₂ₛₚ) and the relaxation time, values measured by the following method will be employed.

### Method for Measuring Relaxation Time and Specific Relaxation Rate (R₂ₛₚ) of Polishing Composition

The relaxation times of silica and a dispersing medium are measured by pulse NMR spectroscopy. Specifically, a polishing composition (silica dispersion liquid) produced to have a silica concentration of 10% by mass and a dispersing medium are each introduced into an NMR tube. Regarding the measurement, the relaxation times are determined by setting the conditions as follows. Regarding the pulse train representing the method or sequence of the application of pulses, using the CPMG method (Carr-Purcell-Meiboom-Gill sequence) of changing the phase of pulses in the spin echo method and thereby collecting signals, scanning is performed four times by setting the time interval τ taken from the application of a 90° pulse to the application of a 180° pulse to 0.5 milliseconds, and T₂, which represents the rate of attenuation, is measured for each sample. In an analyzer (manufactured by Xigo Nanotools, Inc., Acorn Drop) having the temperature of the measurement unit controlled to be constant at 25° C., an NMR tube containing a dispersing medium is inserted into the measurement unit, and the relaxation time of the dispersing medium (T_{medium} (milliseconds)) is measured. Here, the relaxation time of the dispersing medium corresponds to the relaxation time of liquid molecules in the bulk liquid (solvent molecules in a free state, which are not adsorbed to the particle surface). Next, an NMR tube containing a polishing composition produced to have a silica concentration of 10% by mass (silica dispersion liquid) is inserted into the measurement unit, and the relaxation time of silica (Tₛₐₘₚₗₑ (milliseconds)) is measured. Here, the relaxation time of silica corresponds to the sum total time of the relaxation time of liquid molecules adsorbed to the particle surface (solvent molecules that are in contact with or have adsorbed to the particle surface) and the relaxation time of liquid molecules in the bulk liquid (solvent molecules in a free state, which are not adsorbed to the particle surface). Furthermore, the reciprocals of the relaxation time of the dispersing medium (T_{medium} (milliseconds)) and the relaxation time of silica (Tₛₐₘₚₗₑ (milliseconds)) are determined (referred to as R_{medium} (/millisecond) and Rₛₐₘₚₗₑ (/millisecond), respectively). Using these R_{medium} (/millisecond) and Rₛₐₘₚₗₑ (/millisecond), the specific relaxation rate (R₂ₛₚ) is determined by the following Formula (1).

$$\begin{matrix}[ Expression 4 ] & \\ Specific relaxation rate ( {R}_{2 sp} ) = \frac{{R}_{sample}}{{R}_{medium}} - 1 & Formula ( 1 )\end{matrix}$$

In Formula (1) , Rₛₐₘₚₗₑ represents the reciprocal of the relaxation time of silica (Tₛₐₘₚₗₑ (milliseconds)) (Rₛₐₘₚₗₑ=1/Tₛₐₘₚₗₑ (/millisecond)); and

R_{medium} represents the reciprocal of the relaxation time of the dispersing medium (T_{medium} (milliseconds)) (R_{medium}=1/T_{medium} (millisecond)).

Next, the configuration of the polishing composition according to an embodiment of the present invention will be described in detail.

### Silica (Abrasive Grains)

The polishing composition according to an embodiment of the present invention essentially includes silica (silica particles) as abrasive grains, and more preferably, the polishing composition includes colloidal silica as abrasive grains. That is, according to a preferred embodiment of the present invention, silica is colloidal silica. Examples of the method for producing colloidal silica include a sodium silicate method, a sol-gel method, and the like, and colloidal silica produced by any production method may be suitably used. However, from the viewpoint of reducing metallic impurities, colloidal silica produced by a sol-gel method, which is capable of high-purity production, is preferred.

Here, the shape of the silica (silica abrasive grains) is not particularly limited, and the shape may be a spherical shape or may be a non-spherical shape. Specific examples of the non-spherical shape include various shapes such as a polygonal prism shape such as a triangular prism or a tetragonal prism; a cylindrical shape; a straw bag shape in which the central part of a cylinder is inflated compared to the ends; a doughnut shape in which the central part of a cylinder is perforated through; a plate shape; a so-called cocoon-like shape having a constriction in the middle part; a so-called associated type spherical shape in which a plurality of particles are integrated; a so-called konpeito shape having a plurality of protrusions on the surface; and a rugby ball shape, and there are no particular limitations. Meanwhile, the aspect ratio (major axis/minor axis) of silica in the case where the silica has a spherical shape is not particularly limited; however, it is preferable that the aspect ratio is 1.0 or higher and lower than 1.2. In the present specification, regarding the aspect ratio of silica (abrasive grains), images of 300 particles measured by FE-SEM are randomly extracted, the aspect ratios are measured, and the average value of the measured values is employed.

The size of the silica (silica abrasive grains) is not particularly limited. For example, in a case where the silica has a spherical shape, the average primary particle size of the silica (abrasive grains) is preferably 5 nm or more, more preferably 10 nm or more, and even more preferably 20 nm or more. As the average primary particle size of the silica becomes larger, the polishing speed of the object to be polished performed by the polishing composition is increased. Furthermore, the average primary particle size of the silica is preferably 200 nm or less, more preferably 100 nm or less, and even more preferably 50 nm or less. As the average primary particle size of the silica becomes smaller, it is easier to obtain a surface with fewer defects and a smaller degree of roughness, which is caused by polishing using the polishing composition. That is, the average primary particle size of the silica (abrasive grains) is preferably from 5 nm to 200 nm, more preferably from 10 nm to 100 nm, and particularly preferably from 20 nm to 50 nm. Meanwhile, the average primary particle size of the silica (diameter of silica particles (primary particles) can be calculated, under the assumption that the shape of the silica particles is a true spherical shape, based on the specific surface area (SA) of the silica particles calculated by, for example, the BET method. In the present specification, regarding the average primary particle size of the silica, a value measured according to the method described in the following Examples is employed.

The average secondary particle size of the silica (silica abrasive grains) is preferably 25 nm or more, more preferably 35 nm or more, and even more preferably 55 nm or more. As the average secondary particle size of the silica becomes larger, the resistance during polishing is decreased, and polishing can be achieved stably. Furthermore, the average secondary particle size of the silica particles is preferably 1 μm or less, more preferably 500 nm or less, and even more preferably 100 nm or less. As the average secondary particle size of the colloidal silica particles becomes smaller, the surface area per unit mass of the colloidal silica particles becomes larger, the frequency of contact with the object to be polished is increased, and the polishing efficiency is increased. That is, the average secondary particle size of the silica (abrasive grains) is preferably from 25 nm to 1 μm, more preferably from 35 nm to 500 nm, and particularly preferably from 55 nm to 100 nm. In the present specification, regarding the average secondary particle size of the silica, a value measured according to the method described in the following Examples is employed. Meanwhile, the value of the degree of association (average secondary particle size/average primary particle size) calculated from these values is also not particularly limited, and the degree of association is preferably about 1.5 to 5.0.

The silanol group density of the silica (abrasive grains) is not particularly limited; however, the silanol group density (number) of the silica accomplishes an important role for the control of the specific relaxation rate (R₂ₛₚ). Specifically, when the silanol group density (number) of the silica is increased, the specific relaxation rate (R₂ₛₚ) is increased. Therefore, with consideration for the ease of control of the specific relaxation rate (R₂ₛₚ) of the polishing composition to a predetermined range, and the like, the silanol group density of the silica is preferably 5.0 groups/nm² or less, more preferably 3.0 groups/nm² or less, and particularly preferably 2.0 groups/nm² or less. Furthermore, the lower limit of the silanol group density of the silica is preferably 0.5 groups/nm² or more, more preferably 0.8 groups/nm² or more, and particularly preferably 1.0 group/nm² or more. That is, the silanol group density of the silica (abrasive grains) is preferably from 0.5 groups/nm² to 5.0 groups/nm², more preferably from 0.8 groups/nm² to 3.0 groups/nm², and particularly preferably from 1.0 group/nm² to 2.0 groups/nm². By using a silica having such a silanol group density, the polishing composition can be controlled more easily so as to have the desired specific relaxation rate (R₂ₛₚ). The silanol group density of the silica (abrasive grains) can be calculated by the Sears method of using neutralization titration as described in G. W. Sears, Analytical Chemistry, Vol. 28, No. 12, 1956, 1982-1983. In the present specification, regarding the silanol group density of the silica (abrasive grains), a value measured according to the method described in the following Examples is employed.

The average silanol group density is inversely proportional to the true density of the abrasive grains. Therefore, the true density of silica also accomplishes an important role in the control of the specific relaxation rate (R₂ₛₚ). Meanwhile, when it is said that the silanol group density of silica is low, it means that the true density of silica is high (high hardness). Particularly, colloidal silica (abrasive grains) has different densities depending on the production method (for example, a sol-gel method, or a sodium silicate method). Furthermore, even if one production method (for example, a sol-gel method) is employed, the porosity changes with the reaction temperature, the time required for reaction, or the like. Since porosity is considered to affect the hardness of silica itself, it is preferable to know the true density. Here, the true density of silica (abrasive grains) is not particularly limited; however, similarly to the silanol group density of silica, the true density also accomplishes an important role for the control of the specific relaxation rate (R₂ₛₚ). Therefore, with consideration of the ease of control of the specific relaxation rate (R₂ₛₚ) of the polishing composition to a predetermined range, and the like, the true density of silica is preferably more than 1.80 g/cm³, more preferably 1.90 g/cm³ or more, and particularly preferably 2.00 g/cm³ or more. Therefore, according to a preferred embodiment of the present invention, the silica has a true density of 1.80 g/cm³ or more. According to a more preferred embodiment of the present invention, the silica has a true density of 1.90 g/cm³ or more. According to a particularly preferred embodiment of the present invention, the silica has a true density of 2.0 g/cm³ or more. Furthermore, the upper limit of the true density of the silica is preferably 2.20 g/cm³ or less, more preferably 2.18 g/cm³ or less, and particularly preferably 2.15 g/cm³ or less. That is, the true density of the silica (abrasive grains) is preferably more than 1.80 g/cm³ and 2.20 g/cm³ or less, more preferably 1.90 g/cm³ or more and 2.18 g/cm³ or less, and particularly preferably 2.00 g/cm³ or more and 2.15 g/cm³ or less. By using a silica having such a true density, the polishing composition can be controlled more easily so as to have the desired specific relaxation rate (R₂ₛₚ). In the present specification, regarding the true density of the silica (abrasive grains), a value measured according to the method described in the following Examples is employed.

The BET specific surface area of the silica (abrasive grains) is not particularly limited; however, the BET specific surface area is preferably 60 m²/g or more, more preferably 70 m²/g or more, and even more preferably 80 m²/g or more. The upper limit of the BET specific surface area of the silica is preferably 120 m²/g or less, and more preferably 100 m^{2/}g or less. That is, the BET specific surface area of the silica (abrasive grains) is preferably from 60 m²/g to 120 m²/g, more preferably from 70 m²/g to 120 m²/g, and even more preferably from 80 m²/g to 100 m²/g. In the present specification, regarding the BET specific surface area of the silica (abrasive grains), a value measured according to the method described in the following Examples is employed.

Furthermore, the silica may have the surface modified. In the case of using a surface-modified silica as the abrasive grains, a colloidal silica having an organic acid or an organic amine immobilized thereon is preferably used. Immobilization of the organic acid or organic amine to the surface of the colloidal silica contained in the polishing composition is carried out by, for example, chemical bonding of the functional group of the organic acid or organic amine to the surface of the colloidal silica. When the colloidal silica and the organic acid or organic amine are simply allowed to co-exist, immobilization of the organic acid to the colloidal silica is not accomplished. When sulfonic acid, which is a kind of organic acid, is to be immobilized on the colloidal silica, for example, the immobilization can be carried out by the method described in “Sulfonic acid-functionalized silica through quantitative oxidation of thiol groups”, Chem. Commun., 246-247 (2003). Specifically, a colloidal silica having sulfonic acid immobilized on the surface can be obtained by coupling a silane coupling agent having a thiol group, such as 3-mercaptopropyltrimethoxysilane, with the colloidal silica and then oxidizing the thiol group with hydrogen peroxide. Alternatively, when a carboxylic acid is to be immobilized on the colloidal silica, the immobilization can be carried out by, for example, the method described in “Novel Silane Coupling Agents Containing Photolabile 2-Nitrobenzyl Ester for Introduction of a Carboxy Group on the Surface of Silica Gel”, Chemistry Letters, 3, 228-229 (2000). Specifically, a colloidal silica having a carboxylic acid immobilized on the surface can be obtained by coupling a silane coupling agent including a photoreactive 2-nitrobenzyl ester to the colloidal silica and then irradiating the product with light. When an alkylamine, which is a kind of organic amine, is to be fixed to the colloidal silica, the fixation can be carried out by the method described in JP 2012-211080 A can be carried out. Specifically, a colloidal silica having an organic amine immobilized on the surface can be obtained by coupling a silane coupling agent having an alkylamine group, such aminopropyltriethoxysilane, to the colloidal silica.

The size (average primary particle size, average secondary particle size, and aspect ratio) of silica, the silanol group density, the true density, and the BET specific surface area can be appropriately controlled by selection of the production method for silica (abrasive grains), or the like.

The polishing composition includes silica as abrasive grains. Here, the content of the silica is not particularly limited. However, as described above, when the polishing composition according to an embodiment of the present invention is used, even with a small amount (low concentration) of silica, the surface of an object to be polished can be polished efficiently because the silica efficiently exits on the object to be polished. Specifically, the content (concentration) of the silica is preferably 0.002% by mass or more, more preferably 0.02% by mass or more, and even more preferably 0.1% by mass or more, with respect to the polishing composition. The upper limit of the content of the silica is preferably less than 8% by mass, more preferably 5% mass or less, and even more preferably 2% by mass or less, with respect to the polishing composition. That is, the content of the silica is preferably 0.002% by mass or more and less than 8% by mass, more preferably 0.02% by mass or more and 5% by mass or less, and even more preferably 0.1% by mass or more and 2% by mass or less, with respect to the polishing composition. When the content is in such a range, both the increase in the polishing speed and the reduction of scratches (defects) can be achieved in a well-balanced manner, while cost is suppressed to a low level. Meanwhile, in a case where the polishing composition includes two or more kinds of silicas, the content of the silicas means the total amount of these.

### Dispersing Medium

The polishing composition according to an embodiment of the present invention includes a dispersing medium for dispersing various components. Examples of the dispersing medium include water; alcohols such as methanol, ethanol, and ethylene glycol; ketones such as acetone; mixtures thereof, and the like. Among these, water is preferable as the dispersing medium. That is, according to a preferred embodiment of the present invention, the dispersing medium contains water. According to a more preferred embodiment of the present invention, the dispersing medium is substantially composed of water. The above-described term “substantially” means that as long as the desired effects of the present invention can be achieved, a dispersing medium other than water can be included. More specifically, the dispersing medium is composed of from 90% by mass to 100% by mass of water and from 0% by mass to 10% by mass of a dispersing medium other than water; and preferably, the dispersing medium is composed of from 99% by mass to 100% by mass of water and from 0% by mass to 1% by mass of a dispersing medium other than water. Most preferably, the dispersing medium is water. From the viewpoint of suppressing inhibition of the action of other components, water that does not contain impurities as far as possible is preferred, and specifically, pure water or ultrapure water obtained by removing impurity ions with an ion exchange resin and then removing foreign materials by passing through a filter, or distilled water is preferred.

The pH of the polishing composition according to an embodiment of the present invention is not particularly limited; however, the pH of the composition accomplishes an important role in the control of the specific relaxation rate (R₂ₛₚ). More particularly, when the pH of the composition is decreased, the specific relaxation rate (R₂ₛₚ) is increased. Therefore, with consideration of the ease of control of the specific relaxation rate (R₂ₛₚ) of the polishing composition to a predetermined range, or the like, the pH at 25° C. of the polishing composition is preferably lower than 7.5, more preferably lower than 6.0, and particularly preferably 4.0 or lower. Therefore, according to a preferred embodiment of the present invention, the pH at 25° C. of the polishing composition is lower than 7.5. In the present specification, unless particularly stated otherwise, the “pH” means “pH at 25° C.”. Furthermore, the upper limit of pH at 25° C. of the polishing composition is preferably 1.0 or higher, more preferably 2.0 or higher, and particularly preferably 3.0 or higher. That is, the pH at 25° C. of the polishing composition is preferably 1.0 or higher and lower than 7.5, more preferably 2.0 or higher and lower than 6.0, and particularly preferably 3.0 or higher and 4.0 or lower. When a polishing composition having such a pH is used, the polishing composition can be controlled more easily so as to have the desired specific relaxation rate (R₂ₛₚ). Furthermore, silica (abrasive grains) can be dispersed stably. In the present specification, regarding the pH, a value measured with a pH meter (manufactured by Horiba, Ltd., Product. No.: LAQUA (registered trademark)) at 25° C. is employed.

The pH can be adjusted by adding an appropriate amount of a pH adjusting agent. That is, the polishing composition may further include a pH adjusting agent. Here, the pH adjusting agent used as necessary in order to adjust the pH of the polishing composition to a desired value may be any of an acid and an alkali, and the pH adjusting agent may be any of an inorganic compound and an organic compound. Specific examples of the acid include, for example, inorganic acids such as sulfuric acid, nitric acid, boric acid, carbonic acid, hypophosphorous acid, phosphorous acid, and phosphoric acid; and organic acids, such as carboxylic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimellic acid, maleic acid, phthalic acid, malic acid, tartaric acid, citric acid, and lactic acid; organosulfuric acids such as methanesulfonic acid, ethanesulfonic acid, and isethionic acid; and organophosphoric acids such as phytic acid and hydroxyethylidenediphosphonic acid. Among these, lactic acid is particularly preferred. According to a preferred embodiment of the present invention, the polishing composition has a relatively low pH, such as below 7.5. Therefore, it is preferable that the polishing composition further includes an acid.

Specific examples of the alkali include hydroxides of alkali metals, such as potassium hydroxide; amines such as ammonia, ethylenediamine, and piperazine; and salts of quaternary ammoniums such as tetramethylammonium and tetraethylammonium. These pH adjusting agents can be used singly or as mixtures of two or more kinds thereof.

### Other Components

The polishing composition according to an embodiment of the present invention may further include, if necessary, other components such as an oxidizing agent, a metal anticorrosive, an antiseptic agent, an antifungal agent, a water-soluble polymer, and an organic solvent for dissolving a sparingly soluble organic substance. In the following description, an oxidizing agent, a metal anticorrosive, an antiseptic agent, and an antifungal agent, which are preferred other components, will be described.

### Oxidizing Agent

The oxidizing agent that can be added to the polishing composition has an action of oxidizing the surface of an object to be polished and increases the polishing speed of an object to be polished by the polishing composition.

Examples of a usable oxidizing agent include hydrogen peroxide, sodium peroxide, barium peroxide, ozone water, silver(II) salts, iron(III) salts, permanganic acid, chromic acid, dichromic acid, peroxodisulfuric acid, peroxophosphoric acid, peroxosulfuric acid, peroxoboric acid, performic acid, peracetic acid, perbenzoic acid, perphthalic acid, hypochlorous acid, hypobromous acid, hypoiodous acid, chloric acid, chlorous acid, perchloric acid, bromic acid, iodic acid, periodic acid, persulfuric acid, dichloroisocyanuric acid, salts thereof, and the like. These oxidizing agents may be used singly or as mixtures of two or more kinds thereof.

The content of the oxidizing agent in the polishing composition is preferably 0.1 g/L or more, more preferably 1 g/L or more, and even more preferably 3 g/L or more. As the content of the oxidizing agent is larger, the polishing speed of an object to be polished by the polishing composition is further increased.

The content of the oxidizing agent in the polishing composition is preferably 200 g/L or less, more preferably 100 g/L or less, and even more preferably 40 g/L or less. As the content of the oxidizing agent becomes smaller, the material cost for the polishing composition can be suppressed, and in addition, the load of a treatment, that is, a waste water treatment, of the polishing composition after use in polishing can be reduced. Furthermore, the risk for the occurrence of excessive oxidation of the surface of the object to be polished caused by an oxidizing agent may be reduced.

### Metal Anticorrosive

By adding a metal anticorrosive into the polishing composition, the occurrence of dents at the sides of wiring due to polishing using the polishing composition can be further suppressed. Furthermore, the occurrence of dishing on the surface of the object to be polished after being polished using the polishing composition can be further suppressed.

There are no particular limitations on the metal anticorrosive that can be used; however, the metal anticorrosive is preferably a heterocyclic compound or a surfactant. The number of member atoms of the heterocyclic ring in the heterocyclic compound is not particularly limited. Furthermore, the heterocyclic compound may be a monocyclic compound or may be a polycyclic compound having a fused ring. Regarding the metal anticorrosive, compounds may be used singly or as mixtures of two or more kinds thereof. Furthermore, regarding the metal anticorrosive, a commercially available product may be used, or a synthesized product may be used.

Specific examples of a heterocyclic compound that can be used as the metal anticorrosive include, for example, nitrogen-containing heterocyclic compounds such as a pyrrole compound, a pyrazole compound, an imidazole compound, a triazole compound, a tetrazole compound, a pyridine compound, a pyrazine compound, a pyridazine compound, a pyrindine compound, an indolizine compound, an indole compound, an isoindole compound, an indazole compound, a purine compound, a quinolidine compound, a quinoline compound, an isoquinoline compound, a naphthyridine compound, a phthalazine compound, a quinoxaline compound, a quinazoline compound, a cinnoline compound, a pteridine compound, a thiazole compound, an isothiazole compound, an oxazole compound, an isoxazole compound, and a furazan compound.

### Antiseptic Agent and Antifungal Agent

Examples of the antiseptic agent and the antifungal agent used for the present invention include isothiazoline-based antiseptic agents such as 2-methyl-4-isothiazolin-3-one and 5-chloro-2-methyl-4-isothiazolin-3-one; paraoxybenzoic acid esters; and phenoxyethanol. These antiseptic agents and antifungal agents may be used singly or as mixtures of two or more kinds thereof.

### Method for Producing Polishing Composition

The method for producing a polishing composition according to an embodiment of the present invention is not particularly limited, and for example, a polishing composition can be obtained by stirring and mixing abrasive grains and optionally other components in a dispersing medium. That is, the other aspect of the present invention provides a method for producing a polishing composition, the method including mixing silica with a dispersing medium such that the specific relaxation rate (R₂ₛₚ) that can be determined, when measured by pulse NMR spectroscopy, by the following Formula (1) is from 1.60 to 4.20:

[Expression 5]

R₂ₛₚ=(R_{(silica)})/(R_{medium)})−1 Formula (1):

Here, R_{(silica)} represents the reciprocal of the relaxation time of silica (unit:/millisecond); and R_{(medium)} represents the reciprocal of the relaxation time of the dispersing medium (unit:/millisecond). Here, as described above, in order to regulate the specific relaxation rate (R₂ₛₚ) to be from 1.60 to 4.20, it is desirable to control various conditions; however, it is important to control the silanol group density and true density of silica and the pH of the composition. Therefore, it is particularly preferable to set the specific relaxation rate (R₂ₛₚ) to a desired value by controlling at least one (preferably, both) of the silanol group density of silica and the pH of the composition to be the preferable ranges described above.

The temperature at the time of mixing the various components is not particularly limited; however, the temperature is preferably 10° C. to 40° C., and the components may also be heated in order to increase the dissolution rate. Furthermore, the mixing time is not particularly limited.

### Polishing Method and Method for Producing Substrate

As described above, the polishing composition according to an embodiment of the present invention is particularly suitably used for the polishing of an object to be polished containing oxygen atoms and silicon atoms. Therefore, another aspect of the present invention is to provide a polishing method including polishing an object to be polished containing oxygen atoms and silicon atoms using the polishing composition according to an embodiment of the present invention.

Regarding the polishing apparatus, a general polishing apparatus having a polishing table, to which a holder that holds a substrate having an object to be polished or the like, a motor that can change the rotation speed, and the like are attached, the polishing table capable of having a polishing pad (polishing cloth) attached, can be used.

Regarding the polishing pad, a general nonwoven fabric, polyurethane, a porous fluororesin, and the like can be used without any particular limitations. It is preferable that polishing pad is provided with groove processing for collecting the polishing liquid.

There are no particular limitations on the polishing conditions, and for example, the rotation speed of the polishing table (platen) is preferably 10 to 500 rpm. The pressure to be applied to the substrate having an object to be polished (polishing pressure) is preferably 0.5 to 10 psi. The method for supplying the polishing composition to the polishing pad is also not particularly limited, and for example, a method of continuously supplying the polishing composition by means of a pump or the like is employed. This amount of supply is not particularly limited; however, it is preferable that the surface of the polishing pad is covered all the time with the polishing composition according to an embodiment of the present invention.

After completion of polishing, the substrate is washed under tap water, and water droplets adhering onto the substrate are dried by shaking off the droplets by means of a spin dryer or the like, to give a substrate containing oxygen atoms and silicon atoms.

The polishing composition according to an embodiment of the present invention may be a one-liquid type composition, or may be a multi-liquid type composition including a two-liquid type composition obtained by incorporating a portion or the entirety of the polishing composition at an arbitrary mixing ratio. Furthermore, in a case where a polishing apparatus having a plurality of supply routes for the polishing composition is used, two or more polishing compositions that have been prepared in advance may be used such that the polishing composition is mixed in the polishing apparatus.

Furthermore, the polishing composition according to an embodiment of the present invention may be in the form of a stock solution, or may be produced by diluting a stock solution of the polishing composition with water. In a case where the polishing composition is of two-liquid type, the order of mixing and dilution is arbitrary. For example, a case where one of the compositions is diluted with water, and then the dilution and the other composition are mixed, a case where mixing is achieved simultaneously with dilution with water a case where the mixed polishing composition is diluted with water, and the like may be mentioned.

### EXAMPLES

The present invention will be described in more detail by using the following Examples and Comparative Examples. However, the technical scope of the present invention is not intended to be limited only to the following Examples. Unless particularly stated otherwise, the units “percent (%)” and “parts” mean “percent (%) by mass” and “parts by mass”, respectively. In the following Examples, unless particularly stated otherwise, operations were carried out under the condition of room temperature (25° C.)/relative humidity of 40 to 50% RH.

The average primary particle size (nm), average secondary particle size (nm), silanol group density (groups/nm²), true density (g/cm³), and BET specific surface area (m²/g) of silica (abrasive grains) were measured by the following methods.

### Average Particle Size (nm) of Silica

The average primary particle size (nm) of silica (abrasive grains) was calculated for 0.2 g of a silica sample, under the assumption that the shape of the silica particles was a true spherical shape, based on the average value of the specific surface area (SA) of the silica particles calculated from the values measured consecutively for 3 to 5 times by the BET method. From these values, the value of the degree of association (average secondary particle size/average primary particle size) can also be calculated.

The average secondary particle size (nm) of silica (abrasive particles) was measured on the silica sample using a dynamic light scattering type particle size distribution analyzer (UPA-UT151, manufactured by Nikkiso Co., Ltd.). First, abrasive particles were dispersed in pure water, and thus a dispersion liquid having a loading index (scattering intensity of laser light) of 0.01 was produced. Subsequently, the value of the volume average particle size Mv in the UT mode was measured consecutively for 3 to 5 times, and the average value of the values thus obtained was designated as average secondary particle size.

### Silanol Group Density (Groups/nm²) of Silica

The silanol group density (average silanol group density) (groups/nm²) of silica (abrasive grains) was calculated by the Sears titration method using neutralization titration described in G. W. Sears, Analytical Chemistry, Vol. 28, No. 12, 1956, 1982-1983. The Sears titration method is an analytical technique that is generally used when a colloidal silica manufacturer evaluates the number of silanol groups, and this is a method of calculating the number of silanol groups from the amount of the aqueous solution of sodium hydroxide required for changing from pH 4 to pH 9.

Specific first, 1.50 g of colloidal silica as a solid content is collected in a 200-ml beaker, about 100 ml of pure water is added thereto, and thus a slurry is produced. Subsequently, 30 g of sodium chloride is added to the slurry and dissolved therein. Next, 1 N hydrochloric acid is added thereto to adjust the pH of the slurry to about 3.0 to 3.5, and then pure water is added thereto until the amount of the slurry becomes 150 ml. This slurry is adjusted to pH 4.0 using 0.1 N sodium hydroxide at 25° C. using an automatic titration apparatus (manufactured by Hiranuma Sangyo Co., Ltd., COM-1700), and the volume V [L] of the 0.1 N sodium hydroxide solution required for increasing the pH from 4.0 to 9.0 by pH titration is measured. The silanol group density (number of silanol groups) can be calculated by the following Formula (2).

[Expression 6]

ρ=(c×V×N_{A}×10⁻²¹)/(C×S) Formula (2):

In Formula (2), ρ represents the silanol group density (number of silanol groups) (groups/nm²);

c represents the concentration (mol/L) of the sodium hydroxide solution used for titration;

V represents the volume (L) of the sodium hydroxide solution required for increasing the pH from 4.0 to 9.0;

N_{A} represents Avogadro constant (/mol);

C represents the total mass (solid content) (g) of silica; and

S represents the BET specific surface area (nm²/g) of silica.

### True Density (g/cm³) of Silica

The true density (g/cm³) of silica (abrasive grains) is measured according to the following method. Specifically, first, an aqueous solution of silica is introduced into a crucible to an amount of about 15 g as the solid content (silica), and moisture is evaporated at about 200° C. using a commercially available hot plate. Furthermore, in order to eliminate the moisture remaining in the pores of the silica, a heat treatment is performed for one hour at 300° C. in an electric furnace (manufactured by Advantec Toyo Kaisha, Ltd., calcination furnace), and dried silica after the treatment is pulverized in a mortar. Next, 10 g of the dried silica produced as described above is introduced into a 100-ml specific gravity bottle (Wa (g)), the weight of which has been measured in advance with a precision balance (manufactured by A&D Co., Ltd., GH-202), and the weight is measured (Wb (g)). Subsequently, 20 ml of ethanol is added thereto, and the mixture is degassed for 30 minutes in a desiccator under reduced pressure. Subsequently, the specific gravity bottle is filled with ethanol, the bottle is sealed with a stopper, and the weight is measured (Wc (g)). Regarding the specific gravity bottle with which the weight measurement of silica has been finished, the content is disposed of, the specific gravity bottle is washed and then filled with ethanol, and the weight is measured (Wd (g)). From these weights and the temperature of ethanol (t (° C.)) at the time of measurement, the true density is calculated by Formula (3) and Formula (4).

[Expression 7]

Ld=0.80653−0.000867×t Formula (3):

In Formula (3), Ld represents the specific gravity (g/cm³) of ethanol at t° C. [0087]

[Expression 8]

Sg=(Wb−Wa)/(Wd−Wc+Wb−Wa)×Ld Formula (4):

In Formula (4), Sg represents the true density (g/cm³) of silica;

Wa represents the weight (g) of the specific gravity bottle;

Wb represents the total weight (g) of the sample (dried silica) and the specific gravity bottle;

Wc represents the total weight (g) of the sample (dried silica), ethanol, and the specific gravity bottle;

Wd represents the total weight (g) of ethanol and the specific gravity bottle; and

Ld represents the specific gravity (g/cm³) of ethanol determined by Formula (3) described above.

### BET Specific Surface Area (m²/g) of Silica

The specific surface area (m²/g) of silica (abrasive grains) is measured using the BET method. Specifically, a sample (silica) is heated at 105° C. for 12 hours or longer, and moisture is eliminated. The dried silica is pulverized in a mortar, about 0.2 g of the silica is introduced into a cell whose weight has been measured in advance (Wa′ (g)), and the weight is measured (Wb′ (g)). Subsequently, the sample is kept warm at 180° C. for 5 minutes or longer in a heating unit of a specific surface area meter (manufactured by SHIMADZU CORPORATION, FLOWSORB II 2300). Subsequently, the sample is mounted on the measurement unit, and the adsorption area (A [m²]) at the time of degassing is measured. Using this A value, the specific surface area SA [m²/g] is determined by the following Formula (6).

[Expression 9]

SA=A/(Wb′−Wa′) Formula (6):

In Formula (6), SA represents the BET specific surface area (m²/g) of silica;

A represents the adsorption area (m²) at the time of degassing;

Wa′ represents the weight (g) of the cell; and

Wb′ represents the total weight (g) of the sample (dried silica) and the cell.

### Example 1

Abrasive grains 1 were prepared as abrasive grains. The abrasive grains 1 are spherical colloidal silica having an average primary particle size of 35 nm, an average secondary particle size of 69 nm, a degree of association of 2.0, a BET specific surface area of 68 m²/g, a silanol group density of 2.3 groups/nm², and a true density of 1.8 g/cm³.

The abrasive grains 1 were dispersed with stirring in a dispersing medium (pure water) such that the concentration of the abrasive grains in the composition would be 1% by mass, and lactic acid as a pH adjusting agent was added to the composition such that the pH of the polishing composition would be 4.0. Thus, a polishing composition (polishing composition 1-1 was produced (mixing temperature: about 25° C., mixing time: about 10 minutes). Meanwhile, the pH of the polishing composition (liquid temperature: 25° C.) was checked using a pH meter (manufactured by Horiba, Ltd., product No.: LAQUA (registered trademark)).

Furthermore, a polishing composition (polishing composition 1-2) was produced in the same manner as described above, except that the concentration of the abrasive grains 1 in the composition was adjusted to 10% by mass. Using the polishing composition 1-2, the relaxation times of colloidal silica and water were determined according to the method described below, and the specific relaxation rate (R₂ₛₚ) was calculated based on these values. The results are presented in the following Table 1.

### Relaxation Time and Specific Relaxation Rate (R₂ₛₚ) of Polishing Composition

The relaxation times of colloidal silica and water were measured by pulse NMR spectroscopy. Specifically, the polishing composition 1-2 (silica dispersion liquid) and water (dispersing medium) were respectively introduced into an NMR tube. Measurement was determined by setting the following conditions. Regarding the pulse train representing the method or sequence of the application of pulses, using the CPMG method (Carr-Purcell-Meiboom-Gill sequence) of changing the phase of pulses in the spin echo method and thereby collecting signals, scanning is performed four times by setting the time interval τ taken from the application of a 90° pulse to the application of a 180° pulse to 0.5 milliseconds, and T₂, which represents the rate of attenuation, is measured for each sample. In an analyzer (manufactured by Xigo Nanotools, Inc., Acorn Drop) having the temperature of the measurement unit controlled to be constant at 25° C., an NMR tube containing water is inserted into the measurement unit, and the relaxation time of water (T_{water} (milliseconds)) is measured. Next, an NMR tube containing the polishing composition 1-2 is inserted into the measurement unit, and the relaxation time of colloidal silica (Tₛₐₘₚₗₑ (milliseconds)) is measured. Using the reciprocals of the relaxation time of water (T_{water} (milliseconds)) and the relaxation time of colloidal silica (Tₛₐₘₚₗₑ (milliseconds)) (R_{water} (/millisecond) and Rₛₐₘₚₗₑ (/millisecond), respectively), the specific relaxation rate (R₂ₛₚ) is determined by the following Formula (7).

$$\begin{matrix}[ Expression 10 ] & \\ Specific relaxation rate ( {R}_{2 sp} ) = \frac{{R}_{sample}}{{R}_{water}} - 1 & Formula ( 7 )\end{matrix}$$

In Formula (7), Rₛₐₘₚₗₑ represents the reciprocal (/millisecond) of the relaxation time of colloidal silica (Tₛₐₘₚₗₑ (milliseconds)); and

R_{water} represents the reciprocal (/millisecond) of the relaxation time of water (T_{water} (milliseconds)).

### Example 2

Abrasive grains 2 were prepared as abrasive grains. The abrasive grains 2 are spherical colloidal silica having an average primary particle size of 32 nm, an average secondary particle size of 61 nm, a degree of association of 1.9, a BET specific surface area of 90 m²/g, a silanol group density of 1.5 groups/nm², and a true density of 2.1 g/cm³.

The abrasive grains 2 were dispersed with stirring in a dispersing medium (pure water) such that the concentration of the abrasive grains in the composition would be 1% by mass, and lactic acid as a pH adjusting agent was added to the composition such that the pH of the polishing composition would be 5.0. Thus, a polishing composition (polishing composition 2-1) was produced (mixing temperature: about 25° C., mixing time: about 10 minutes). Meanwhile, the pH of the polishing composition (liquid temperature: 25° C.) was checked using a pH meter (manufactured by Horiba, Ltd., product. No.: LAQUA).

Furthermore, a polishing composition (polishing composition 2-2) was produced in the same manner as described above, except that the concentration of the abrasive grains 2 in the composition was adjusted to 10% by mass. Using the polishing composition 2-2, the relaxation times of colloidal silica and water were determined in the same manner as in Example 1, and the specific relaxation rate (R₂ₛₚ) was calculated based on these values. The results are presented in the following Table 1.

### Example 3

A polishing composition was produced in the same manner as in Example 2, except that lactic acid (pH adjusting agent) used in Example 2 was added such that the pH of the polishing composition (liquid temperature: 25° C.) would be 4.0. Meanwhile, a polishing composition in which the concentration of the abrasive grains 1 in the composition was 1% by mass was referred to as polishing composition 3-1, and a polishing composition in which the concentration of the abrasive grains 1 in the composition was 10% by mass was referred to as polishing composition 3-2.

Using the polishing composition 3-2, the relaxation times of colloidal silica and water were determined in the same manner as in Example 1, and the specific relaxation rate (R₂ₛₚ) was calculated based on these values. The results are presented in the following Table 1.

### Example 4

A polishing composition was produced in the same manner as in Example 2, except that lactic acid (pH adjusting agent) used in Example 2 was added such that the pH of the polishing composition (liquid temperature: 25° C.) would be 3.0. Meanwhile, a polishing composition in which the concentration of the abrasive grains 1 in the composition was 1% by mass was referred to as polishing composition 4-1, and a polishing composition in which the concentration of the abrasive grains 1 in the composition was 10% by mass was referred to as polishing composition 4-2.

Using the polishing composition 4-2, the relaxation times of colloidal silica and water were determined in the same manner as in Example 1, and the specific relaxation rate (R₂ₛₚ) was calculated based on these values. The results are presented in the following Table 1.

### Example 5

A polishing composition was produced in the same manner as in Example 2, except that lactic acid (pH adjusting agent) used in Example 2 was added such that the pH of the polishing composition (liquid temperature: 25° C.) would be 2.0. Meanwhile, a polishing composition in which the concentration of the abrasive grains 1 in the composition was 1% by mass was referred to as polishing composition 5-1, and a polishing composition in which the concentration of the abrasive grains 1 in the composition was 10% by mass was referred to as polishing composition 5-2.

Using the polishing composition 5-2, the relaxation times of colloidal silica and water were determined in the same manner as in Example 1, and the specific relaxation rate (R₂ₛₚ) was calculated based on these values. The results are presented in the following Table 1.

### Comparative Example 1

A polishing composition was produced in the same manner as in Example 2, except that lactic acid used in Example 2 was not added. Meanwhile, the pH of the polishing composition obtained in this manner (liquid temperature: 25° C.) was 7.5. A polishing composition in which the concentration of the abrasive grains 1 in the composition was 1% by mass was referred to as comparative polishing composition 1-1, and a polishing composition in which the concentration of the abrasive grains 1 in the composition was 10% by mass was referred to as comparative polishing composition 1-2.

Using the comparative polishing composition 1-2, the relaxation times of colloidal silica and water were determined in the same manner as in Example 1, and the specific relaxation rate (R₂ₛₚ) was calculated based on these values. The results are presented in the following Table 1.

### Comparative Example 2

Abrasive grains 3 were prepared as abrasive grains. The abrasive grains 3 are cocoon-like colloidal silica having an average primary particle size of 35 nm, an average secondary particle size of 67 nm, a degree of association of 1.9, a BET specific surface area of 78 m²/g, an average silanol group density of 5.7 groups/nm², and a true density of 1.8 g/cm³.

The abrasive grains 3 were dispersed with stirring in a dispersing medium (pure water) such that the concentration of the abrasive grains in the composition would be 1% by mass, and thus a polishing composition (comparative polishing composition 2-1) was produced (mixing temperature: about 25° C., mixing time: about 10 minutes). The pH of the polishing composition thus obtained (liquid temperature: 25° C.) was 7.5.

A polishing composition (comparative polishing composition 2-2) was produced in the same manner as described above, except that the concentration of the abrasive grains in the composition was adjusted to 10% by mass. Using this comparative polishing composition 2-2, the relaxation times of colloidal silica and water were determined in the same manner as in Example 1, and the specific relaxation rate (R₂ₛₚ) was calculated based on these values. The results are presented in the following Table 1.

### Comparative Example 3

A polishing composition was produced in the same manner as in Comparative Example 2, except that lactic acid used as a pH adjusting agent in Comparative Example 2 was added such that the pH of the polishing composition would be 4.0. Meanwhile, a polishing composition in which the concentration of the abrasive grains 3 in the composition was 1% by mass was referred to as comparative polishing composition 3-1, and a polishing composition in which the concentration of the abrasive grains 3 in the composition was 10% by mass was referred to as comparative polishing composition 3-2.

Using the comparative polishing composition 3-2, the relaxation time of colloidal silica and water were determined in the same manner as in Example 1, and the specific relaxation rate (R₂ₛₚ) was calculated based on these values. The results are presented in the following Table 1.

### Comparative Example 4

A polishing composition was produced in the same manner as in Comparative Example 2, except that lactic acid used as a pH adjusting agent in Comparative Example 2 was added such that the pH of the polishing composition would be 3.0. Meanwhile, a polishing composition in which the concentration of the abrasive grains 3 in the composition was 1% by mass was referred to as comparative polishing composition 4-1, and a polishing composition in which the concentration of the abrasive grains 3 in the composition was 10% by mass was referred to as comparative polishing composition. 4-2.

Using the comparative polishing composition 4-2, the relaxation time of colloidal silica and water were determined in the same manner as in Example 1, and the specific relaxation rate (R₂ₛₚ) was calculated based on these values. The results are presented in the following Table 1.

For the polishing compositions 1-1, 2-1, 3-1, 4-1, and 5-1 obtained in Examples 1 to 5 and the comparative polishing compositions 1-1, 2-1, 3-1, and 4-1 obtained in Comparative Examples 1 to 4 as described above, the polishing speed and defects (number of scratches) were evaluated according to the methods described below. These results are presented in the following Table 1. In the following Table 1, “TEOS RR” means the polishing speed.

### Polishing Speed

The polishing speed (TEOS RR) obtained when an object to be polished (TEOS substrate) was polished using each of the polishing compositions thus obtained under the following polishing conditions, was measured.

### Polishing Conditions

Polishing machine: Small-sized tabletop polishing machine (manufactured by Engis Japan Corp., EJ380IN)

Polishing pad: Pad made of hard polyurethane (manufactured by Nitta Haas, Inc., IC1000)

Rotation speed of platen (table): 60 [rpm]

Rotation speed of head (carrier): 60 [rpm]

Polishing pressure: 3.0 [psi]

Flow rate of polishing composition (slurry): 100 [ml/min]

Polishing time: 1 [min]

The polishing speed (polishing rate) was evaluated by determining the film thicknesses of the object to be polished before and after polishing using a light interference type film thickness measurement apparatus (manufactured by SCREEN Holdings Co., Ltd., Lambda Ace VM2030), and dividing the difference of the film thicknesses by the polishing time (see the following formula).

$$\begin{matrix}[ Expression 11 ] & \\ Polishing rate [ Å \text{/} min ] = \frac{\begin{matrix}Film thickness [ Å ] before polishing - \\ film thickness [ Å ] after polishing\end{matrix}}{Polishing time [ min ]} & \end{matrix}$$

### Defects (Number of Scratches)

Defects (number of scratches) was evaluated according to the method described below, using the various polishing compositions obtained as described above. Specifically, regarding the number of scratches on the surface of the object to be polished, defects having a length of 0.13 μm or greater on the entire surface of a wafer (provided that the area along the circumference and having a width of 2 mm was excluded) were detected using a defect detecting apparatus (wafer inspection apparatus), “SURFSCAN (registered trademark) SP2” manufactured by KLA-Tencor Corp. All of the defects thus detected were observed with a Review-SEM (RS-6000, manufactured by Hitachi High-Technologies Corp.), and thereby the number of defects (scratches) was counted. The number of defects (scratches) thus obtained was evaluated according to the following evaluation criteria.

### Evaluation Criteria for Scratches

⊙: There are 20 or fewer defects having a length of 0.13 μm or greater.

◯: There are from 21 to 30 defects having a length of 0.13 μm or greater.

Δ: There are from 31 to 50 defects having a length of 0.13 μm or greater.

x: There are 51 or more defects having a length of 0.13 μm or greater.

TABLE 1

| | Colloidal silica (abrasive grains) | | | | | | | | | | |
|---|---|---|---|---|---|---|---|---|---|---|---|
| | | | BET | Silanol | | | | | | | |
| | Primary | Secondary | specific | group | | Specific | | Performance | | | |
| | Particle | particle | surface | density | True | relaxation | Relaxation | pH | | | |
| | size | size | area | (groups/ | density | rate | time | adjusting | | TEOS RR | |
| | (nm) | (nm) | (m²/g) | m²) | (g/cm³) | (R₂ₛₚ) | (milliseconds) | agent | pH | (Å/minute) | Scratches |
| Example | 35 | 69 | 68 | 2.3 | 1.8 | 2.47 | 707.1 | Lactic | 4 | 1089 | ◯ |
| 1 | | | | | | | | acid | | | |
| Example | 32 | 61 | 90 | 1.5 | 2.1 | 2.58 | 686.3 | Lactic | 5 | 919 | ⊙ |
| 2 | | | | | | | | acid | | | |
| Example | 32 | 61 | 90 | 1.5 | 2.1 | 3.46 | 534.8 | Lactic | 4 | 1563 | ⊙ |
| 3 | | | | | | | | acid | | | |
| Example | 32 | 61 | 90 | 1.5 | 2.1 | 3.74 | 503.8 | Lactic | 3 | 1819 | ⊙ |
| 4 | | | | | | | | acid | | | |
| Example | 32 | 61 | 90 | 1.5 | 2.1 | 4.15 | 477.1 | Lactic | 2 | 1210 | ⊙ |
| 5 | | | | | | | | acid | | | |
| Comparative | 32 | 61 | 90 | 1.5 | 2.1 | 1.44 | 980.4 | — | 7.5 | 53 | X |
| Example 1 | | | | | | | | | | | |
| Comparative | 35 | 67 | 78 | 5.7 | 1.8 | 5.98 | 342.1 | — | 7.5 | 13 | X |
| Example 2 | | | | | | | | | | | |
| Comparative | 35 | 67 | 78 | 5.7 | 1.8 | 4.85 | 408.3 | Lactic | 4 | 29 | X |
| Example 3 | | | | | | | | acid | | | |
| Comparative | 35 | 67 | 78 | 5.7 | 1.8 | 4.21 | 458.4 | Lactic | 3 | 179 | X |
| Example 4 | | | | | | | | acid | | | |

As is obvious from Table 1 described above, it was found that the polishing compositions of Examples could further increase the polishing speed for a TEOS substrate and reduce scratches on the surface of the TEOS substrate, compared to the polishing compositions of Comparative Examples.

The present patent application is based on Japanese Patent Application No. 2016-140613 filed on Jul. 15, 2016 and Japanese Patent Application No. 2016-224956 filed on Nov. 18, 2016, the entire disclosures of which are incorporated herein by reference.

1. A polishing composition comprising silica and a dispersing medium,
the polishing composition having, when analyzed by pulse NMR spectroscopy, a specific relaxation rate (R₂ₛₚ) of from 1.60 to 4.20 as determined by the following Formula (1):
[Expression 1]
R₂ₛₚ=(R_{(silica)})/(R_{(medium)})−1 Formula (1):
wherein R_{(silica)} represents a reciprocal of a relaxation time of silica (unit:/millisecond), and R_{(medium)} represents a reciprocal of a relaxation time of a dispersing medium (unit:/millisecond).

2. The polishing composition according to claim 1, wherein a relaxation time of silica when analyzed by pulse NMR spectroscopy is from 460 milliseconds to 900 milliseconds.

3. The polishing composition according to claim 1, wherein the silica is colloidal silica.

4. The polishing composition according to claim 1, wherein the dispersing medium includes water.

5. The polishing composition according to claim 1, wherein the pH at 25° C. is lower than 7.5.

6. The polishing composition according to claim 1, wherein the silica has a true density of 1.90 g/cm³ or higher.

7. The polishing composition according to claim 1, wherein the polishing composition is used for polishing an object to be polished containing oxygen atoms and silicon atoms.

8. A method for producing a polishing composition, the method comprising mixing silica with a dispersing medium such that a specific relaxation rate (R₂ₛₚ), which is obtainable when analyzed by pulse NMR spectroscopy and is determined by the following Formula (1), is from 1.60 to 4.20:
[Expression 2]
R₂ₛₚ=(R_{(silica)})/(R_{(medium)})−1 Formula (1):
wherein R_{(silica)} represents a reciprocal of a relaxation time of silica (unit:/millisecond), and R_{(medium)} represents a reciprocal of a relaxation time of a dispersing medium (unit:/millisecond).

9. A polishing method comprising polishing an object to be polished containing oxygen atoms and silicon atoms using the polishing composition according to any one of claim 1.
